(19) United States
(12) Patent Application Publication
(10) Pub. No.: US 2008/0083448 A1
(43) Pub. Date: Apr. 10, 2008

(54) INTERCONNECT FOR THIN FILM PHOTOVOLTAIC MODULES

(76) Inventor: PETER G. BORDEN, San Mateo, CA (US)

Correspondence Address: Applied Materials, Inc.;Patent Counsel, Legal Affairs Dept., MS/2061, P.O. BOX 450A, Santa Clara, CA, 95052, US

(21) Appl. No.: 11/537,285

(22) Filed: Sep. 29, 2006

(51) Int. Cl. H02N 6/00

(52) U.S. Cl. 136/243

(57) ABSTRACT

The present invention relates to configuring and wiring together cells in TF PV modules. According to one aspect, cells within the module are adjusted in size to compensate for known process non-uniformity. According to another aspect, the module is divided into a number of smaller series-connected sub-modules that are then wired in parallel. According to another aspect, the module and/or sub-module may have a non-rectangular shape. According to another aspect, lithography and etch processes are preferably used to form interconnects. In another embodiment, contact pads are formed using photolithographic processes, which may be used to mount protect diodes to minimize the risk of damage due to shading or non-uniformity.

### FIELD OF THE INVENTION

The present invention relates to methods for making interconnections used in thin film photovoltaic (TF PV) modules, and more particularly to improved interconnect techniques that allow for TF PV modules to be divided into sub-modules, which can be further interconnected together and/or connected to separate outputs.

### BACKGROUND OF THE INVENTION

TF PV modules offer a potential cost advantage over other types of photovoltaic modules, such as modules based on silicon wafers. However, such modules suffer from a number of drawbacks, including lower efficiency, lower reliability, and incompatibility with the balance of the system design. As a result, despite their potential cost advantage, TF PV modules enjoy only about a 10% share of the market as compared to about a 90% share for silicon modules.

To illustrate the conventional drawbacks even further, a conventional method for forming and configuring a TF PV module is described as follows. Thin film material layers are deposited on the surface of a large substrate, typically glass. During this process, a set of scribes are made at regular spacing, most commonly using lasers, but occasionally using mechanical scribing. The combination of the scribes and successive depositions form long series-connected photovoltaic regions.

As shown in FIG. 1A, the large glass substrate, which may be several square meters in area, is then cut into sections, which may be on the order of 1000×1300 mm, to form modules 100. Using laser scribing for example, the film is also removed from the surface of the substrate around the periphery to isolate the cells 102 from the edge. Each cell may be 10 mm wide and run the full length of the module. Finally, terminals 104 are bonded to the end cells 102-L and 102-R.

The electrical equivalent circuit of module 100 is shown in FIG. 1B. Each cell 102 is a diode 110 with a current generator 112. For simplicity, this model neglects resistance elements. As shown, the cells are connected in series during the formation process. The photocurrent generated in the n^{th} cell is I_{Ln}. If all cells generate exactly the same photocurrent, then the module delivers this current at the output terminals. However, if one of the cells in the series string generates less current, it will limit the current in that cell. Because of the series connection, the output current of the entire module will be limited by a similar amount. Therefore, for example, by shading 10% of one cell, corresponding to 0.1% of the module area if there are 100 cell stripes, it is possible to reduce the module current—and, therefore, power (since power=current×voltage)—by 10%. This can result from a variety of factors such as shadowing. For example, at the start and end of the day objects cast long shadows that may non-uniformly fall on a module, or a vent on a roof can cast a shadow during the middle of the day. Other factors include process variation (for example, non-uniformity in a deposition system) and degradation over time. As for process variation, it is well known that small modules typically have higher efficiency than large modules, because it is much easier to achieve good uniformity in a small area than a large area, so that small modules have less current limiting variation than large modules.

However it is caused, this current limitation can also damage the module. Normally, PV cells operate in forward bias. If one cell in a string is current limited because of shading, for example, then that cell may become reverse biased under short circuit conditions. Excess reverse bias can damage that cell. For this reason, modules using silicon wafers have built-in protect diodes. However, it is difficult to install such diodes within thin film modules, as it is not easy to form terminals for such diodes using laser scribing. It should be noted that TF PV modules are often leaky, and this somewhat mitigates the potential damage of reverse biasing a cell.

Another problem hindering the adoption of conventional TF PV modules is that in practice, there are limitations on the size, shape and nature of the interconnect regions between cells. Because laser scribing causes edge damage, it is preferred to make the width of each cell relatively large—on the order of a centimeter—so that the damage takes up a relatively small fraction of the cell stripe area. Making narrower cells would also require more scribing time and increase cost. Also, scribing is an ablative process, so it is easiest to make long, straight cuts and most difficult to make contact pads, regions exposing under-layers, or regions with complex, 2-dimensional shapes.

It will be appreciated, therefore, that a process for configuring and wiring a thin-film photovoltaic module that overcomes these and other conventional limitations would improve the attractiveness of such types of modules.

### SUMMARY OF THE INVENTION

The present invention relates to configuring and wiring together cells in TF PV modules. According to one aspect, cells within the module are adjusted in size to compensate for known process non-uniformity. According to another aspect, the module is divided into a number of smaller series-connected sub-modules that are then wired in parallel. According to another aspect, the module and/or sub-module may have a non-rectangular shape. According to another aspect, lithography and etch processes are preferably used to form interconnects. In another embodiment, contact pads are formed using photolithographic processes, which may be used to mount protect diodes to minimize the risk of damage due to shading or non-uniformity. In another embodiment, protect diodes are included as part of the patterning.

These and other improvements provided by the invention can compensate for processing non-uniformity afflicting TF PV modules and reduce susceptibility to shading and non-uniform degradation, thereby increasing their short- and long-term efficiency, among many other advantages.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIGS. 1A and 1B are diagrams illustrating conventional configurations of TF PV modules;

FIG. 2 is a diagram illustrating a TF PV module configured in accordance with one embodiment of the invention;

FIGS. 3A and 3B illustrate a TF PV module configured in accordance with another embodiment of the invention;

FIG. 4 is a diagram illustrating techniques for processing a TF PV module to accomplish the novel configurations according to certain aspects of the invention;

FIG. 5 illustrate example techniques for configuring a TF PV module with protect diodes in accordance with certain aspects of the invention;

FIG. 6 illustrates example techniques for wiring a TF PV module in accordance with certain aspects of the invention;

FIGS. 7A and 7B illustrate example techniques for configuring a TF PV module with integrated protect diodes in accordance with certain aspects of the invention; and

FIGS. 8A and 8B illustrate non-rectangular module examples made possible in accordance with the principles of the invention.

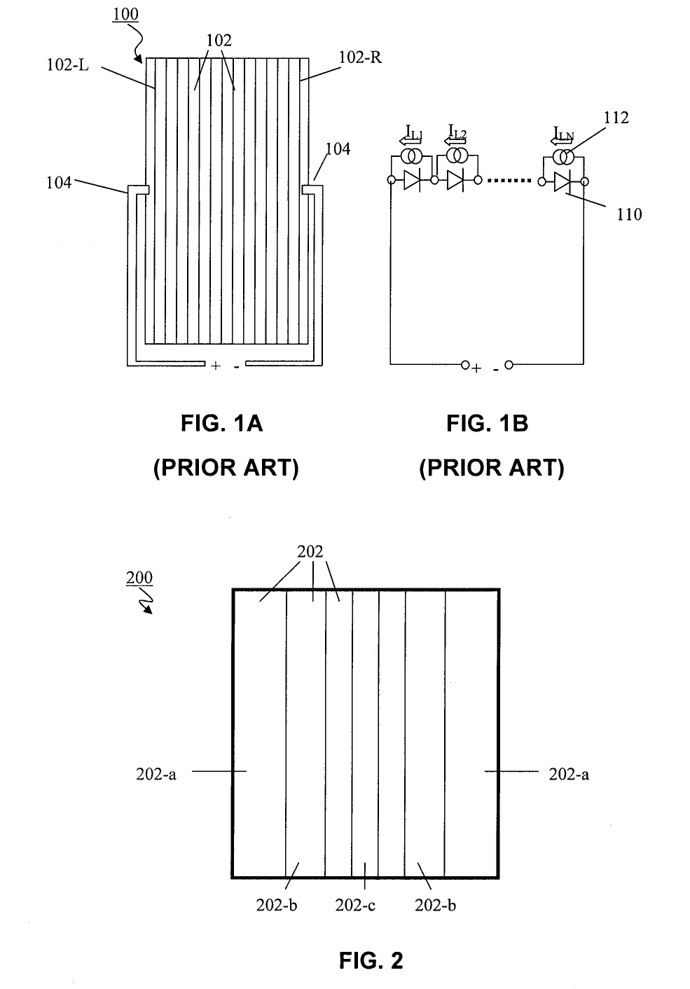

### DESCRIPTION OF REFERENCE NUMERALS ON THE DRAWINGS

The following listing of reference numerals used in the drawings is intended to be illustrative rather than limiting, and the corresponding descriptions are not intended in any way to provide express definitions of any terms used in the specification, unless otherwise explicitly set forth in the foregoing descriptions. Those skilled in the art will appreciate various substitutions and modifications to the elements in the drawings after being taught by the present invention.

100 module

102 cell

104 terminal

110 diode

112 current generator

200 module

202 cell

300 module

302 sub-module

306 set

310 first common node

312 second common node

320 output bus

402 photovoltaic stack

404 substrate

412 mask

420 cell isolation mask lines

422 horizontal sub-module mask lines

424 vertical sub-module mask lines

500 sub-module

502 cell interconnects

504 pad regions

506 protect diode

602 vertical bus

604 horizontal bus

610 substrate

612 active cell area

702 cell

704 isolation cut

706 protect diode

708 interconnect

710 interconnect

712 transparent conductor layer

714 semiconducting layer

716 metal layer

718 substrate

802 stripes

804 sub-modules

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to one general aspect, the present invention recognizes that many advantages in TF PV module efficiency, flexibility, cost and reliability can be achieved by configuring and/or interconnecting such modules in new and useful ways. For example, the present invention recognizes that smaller modules are typically more efficient due to their higher process uniformity. As another example, the present invention recognizes that there is typically less Voc than Isc variation due to non-uniformities.

According to another general aspect, the present invention recognizes that using photolithographic processes to process a TF PV module provides unique abilities to configure and interconnect cells in such modules. Because lithography exposes an entire region through a mask, it is possible to make any density of interconnects, and any shape of interconnects, without added cost. There is very little edge damage, and the cut regions can be made small (a few microns vs. tens or hundreds of microns), so the cells can be relatively narrow. Furthermore, etching of lithographically-defined areas allows exposure of under-layers, for example, to make contacts or interconnects. Co-pending and commonly-owned applications Ser. Nos. 11/395,080, 11/394,721 and 11/394,723 provide example implementations of using such photolithographic processes to form and interconnect cells in a TF PV module, the contents of each application being incorporated herein by reference. The present invention can exploit these types of processes in new and useful ways.

In a first example embodiment of the invention shown in FIG. 2, a module 200 is divided into photovoltaic regions, or cells 202, that are connected in series as done in the prior art. Unlike the prior art, however, where all cells have the same area, the areas of these cells are adjusted to compensate for known process variation.

For example, in some cases it is difficult to achieve ideal uniformity over a large substrate area of several square meters. Such non-uniformity may be desirable in certain cases if it enables the user to employ a faster thin-film growth rate or more efficient use of consumables. The effect on cell current at the maximum power point, Iₘₐₓ, may be determined by fabricating and testing a module. Alternately, small cells could be formed by, for example, placing small substrates on a larger carrier. These small cells can be tested to map the performance with respect to location in the deposition system. Once Iₘₐₓ is mapped for a particular fabrication process, it is possible to adjust the area of the cells within the module to compensate for this non-uniformity.

For example, suppose it is determined that Iₘₐₓ is degraded 10% within 2 cm of the module edge, 5% within 4 cm of the edge, and is uniform to within 1% inside this 6 cm total edge region. Further assume that the width of a nominal cell 202-c in the central “uniform” region is 1 cm (only three are shown in FIG. 2 for ease of illustration, but there can be many more). In accordance with this embodiment of the invention, the two outermost cells 202-a on each edge (only one on each edge is shown in FIG. 2 for ease of illustration) are made 1.1 cm wide, so that their Iₘₐₓ equals that of a cell in the uniform region. The next two inner cells 202-b on each edge are made 1.05 cm wide (only one on each edge are shown in FIG. 2 for ease of illustration), to compensate for their 5% degradation. Therefore, the currents at the maximum power point of all cells are matched, and the module suffers minimal degradation due to the edge non-uniformity.

Any number of conventional methods of dividing and interconnecting cells in a TF PV module can be used in this embodiment, including laser scribing or etch and deposition processes. Those skilled in the art will appreciate how such conventional methods can be modified to obtain different cell sizes rather than equal cell sizes after being taught by the present invention on how to determine the different sizes.

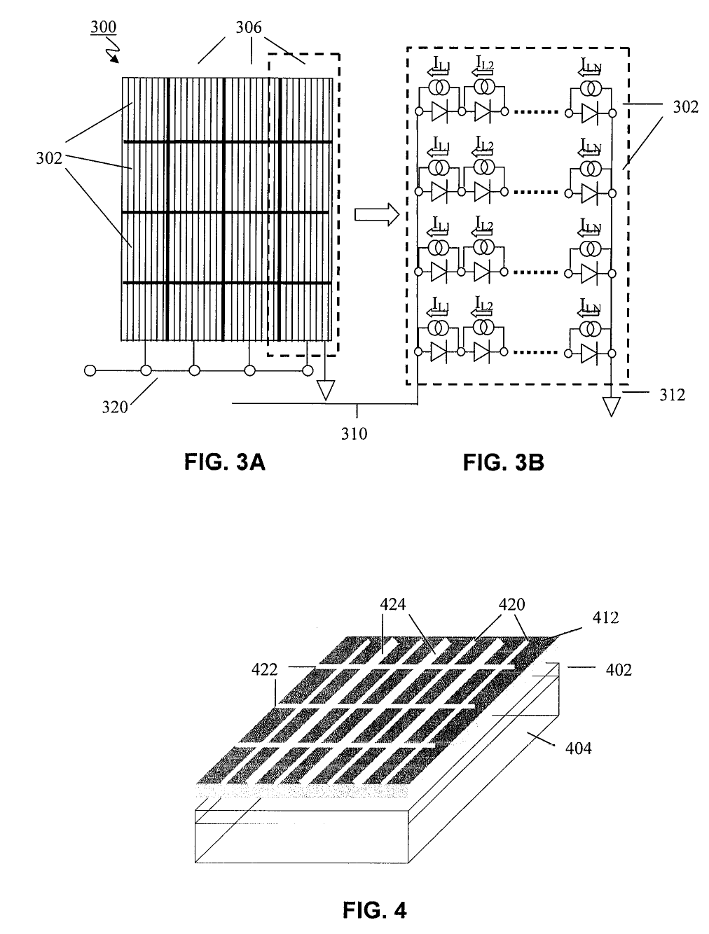

Another embodiment of the invention will now be described in connection with FIGS. 3A and 3B. In this embodiment, the module is divided into a number of sub-modules which are connected together in new and useful ways. In one example, the cells within each sub-module are series connected, and the sub-modules are parallel connected. This results in improved performance because regions are easier to match in voltage than current.

One example implementation of this embodiment is shown in FIG. 3A. As shown in this example, the module 300 is divided into 16 sub-modules 302. As further shown in FIG. 3A, the 16 sub-modules 302 are arranged in four sets 306 of four sub-modules each. Those skilled in the art will appreciate that various divisions into various numbers of sub-modules are possible, that it is not necessary for each set to have the same number of sub-modules, and that the number of sets and the number of sub-modules per set can be different. Moreover, although not shown in detail, in some embodiments, the areas and cells of each sub-module formed by the above process are equal. In other embodiments, the areas of the sub-modules and/or cells therein are varied to account for process variation or other factors.

An equivalent circuit of one set 306 is shown in FIG. 3B. As shown in FIG. 3B, the cells in each sub-module 302 are series connected, and the series connected sub-modules 302 within each set are connected in parallel. As further shown in FIG. 3B, in this configuration, each sub-module 302 is thus connected between a first (e.g. output) common node 310 and a second (e.g. ground) common node 312. It should be apparent that the sub-modules 302 in the other sets 306 can be similarly configured and connected as shown in FIG. 3B.

Returning to FIG. 3A, the four sets 306 are connected together in parallel. In this example, this is accomplished by connecting the first common node 310 of each set to a common output bus 320.

It should be noted that the number of sub-modules could be any number of two or more. However, a larger number (>10) is preferable because it reduces sensitivity to non-uniformity or shading of part of the module, as might be seen in building integrated photovoltaic (BIPV) applications, or in dense fields of modules, especially at the start and end of the day when shadows are longer.

According to an aspect of the invention, the total current of module 300 will likely be higher than an undivided module having the same total cell area. Being smaller in area (e.g. 1/16) than the total area of the whole module, each sub-module 302 will likely be more uniform than what is typically possible over the full module area. Accordingly, it is less likely that the current of individual cells in each sub-module 302 will be substantially different from other cells, thus reducing the likelihood of current limiting within a sub-module. Moreover, sub-modules 302 that have process defects or that exhibit substantial process non-uniformity will be more likely to be localized such that current in other sub-modules is not affected. The net result is that the total current of the module 300 will likely be closer to the optimal current associated with a given optimal process uniformity. Additional techniques for maintaining optimal current in accordance with the invention, such as the inclusion of protect diodes, as discussed in more detail below, can also be used.

As described above, the four columns 306 of cells are wired in parallel, and these four outputs are connected in parallel via common bus 320. This obtains the advantage of parallel wiring of cells, which is a preferred configuration to minimize losses due to shading, non-uniformity, or local degradation.

According to another aspect of the invention, the module output voltage can be maintained the same as an undivided module by making the width of the cells within each sub-module four times smaller (i.e. by increasing the number of cells in each sub-module by a factor of four). For example, whereas an undivided module with an output voltage of 60 volts has a cell width of 1 cm, the divided module 300 is fabricated with each cell having a width of 0.33 cm. Preferably, this is achieved using the lithographic techniques of the incorporated co-pending applications, which makes possible narrow line-width for the interconnect regions on the order of 20-30 μm. However, another possible embodiment uses laser scribing for some or all of the interconnects.

The concepts of the invention can include forming cell regions of non-rectangular shapes. This may be desirable in certain applications such as building integrated photovoltaics (BIPV), where, for example, a triangular module may be desirable as an architectural element. A triangular module is difficult to make with conventional patterning, as the cell stripes are not of constant length and, therefore, not current matched. However, these concepts enable fabrication of stripes varying in both length and width. In addition, the high spatial resolution of lithography allows the longest stripe to be very narrow, so that the shorter stripe can be of limited width, thereby reducing power loss incurred as the current flows through the relatively high resistivity transparent conductor on the cell surface.

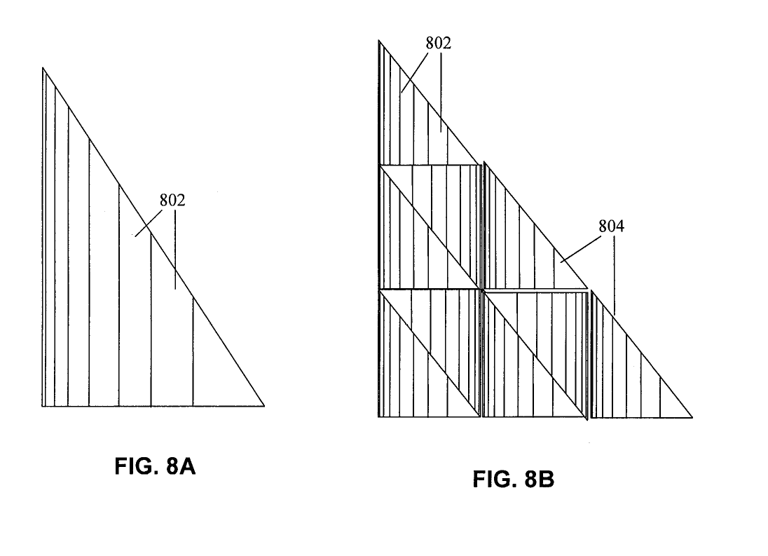

As shown in the right triangle examples in FIGS. 8A and 8B, the widths of the stripes 802 can increase linearly, so that each stripe is of constant area. This provides current matching. In some embodiments, an example of which is illustrated in FIG. 8B, multiple non-rectangular shapes 804 are provided in order to make a larger non-rectangular figure. Using smaller sub-modules 804 enables construction of a large non-rectangular shape while limiting the width of the stripes to a practical value (on the order of 1 cm, depending on the cell technology). The sub-areas 804 can be wired together using methods similar to those employed for the module as shown and described in connection with FIG, 3A.

An example method of configuring a module using photolithographic techniques such as that described in co-pending application Ser. No. 11/394,723 is illustrated in more detail in FIG. 4. As shown in FIG. 4, a stack 402 of photovoltaic material is deposited on a substrate 404 which is, for example, a 3mm thick sheet of glass. As described in the co-pending applications, the stack can include a 0.1 μm bottom layer corresponding to the opaque metal electrode—typically molybdenum—in contact with the glass substrate 404, and a 2 μm layer of CIGS material capped with a 0.07 μm buffer layer of CdS (the CIGS layer or CIGS+CdS layers can be referred to as a semiconducting layer) on top of the Mo layer. The initial stack can further include a top transparent conductor layer, such as aluminum-doped ZnO, or it can be added later.

After depositing the photovoltaic stack 402, the stack is coated with a photoresist layer (not shown) using, for example a spray, dip or roll-on process. The thickness can be 1-10 μm and the material can be Shipley 3612. As further shown in FIG. 4, mask 412 is suspended about 10 um above, or in contact with stack 402. Mask 412 includes vertical (with respect to the orientation of the drawing) lines 420 (e.g. 30 μm wide, and about 0.33 to 1 cm apart, depending on the design) through which the photoresist can be exposed. As explained in more detail below, and in the co-pending applications, these lines 410 isolate the individual cells of the module. Differently from the co-pending applications, however, mask 412 further includes four horizontal lines 422 (with respect to the orientation of the drawing) and four wide vertical lines 424 that are used to define the sub-modules. In one example, the lines 422 can be about 100 μm wide and the lines 424 can be about 100 μm wide. The resist is exposed through the mask 412, the mask is removed and the exposed resist is developed to complete the pattern. Lines 422 and 424 in some cases are made wider than the cell isolation lines to leave room for metal interconnects.

It should be noted that the number of lines 420 defining individual cells can be many more than illustrated in FIG. 4, and that the number of lines 422 and 424 will depend on the number of sub-modules to be created. Many variations from the numbers provided in the illustrations are possible.

Next, a staged etch process is used to cut through the stack 402 down to the substrate 404 through the exposed lines, thereby isolating the cells and dividing the module into sub-modules. In one possible example described in more detail in co-pending application Ser. No. 11/395,080, a HCl or CH₃COOH solution can be used to etch through the top ZnO layer of stack 402. Then an etch mixture, such as a H₂SO₄+H₂O₂ mixture or H₂SO₄+HNO₃ mixture diluted with water, is used to etch the CIGS material in the stack 402 through the patterned photoresist down to the underlying metal layer. For the underlying Mo layer, an etch such as PAN (phosphoric acid, acetic acid and nitric acid H₃PO₄+CH₃COOH+HNO₃) can be used. In some cases, it may be necessary to precede this etch with a short etch to remove a thin MoSe₂ layer at the CIGS-Mo interface, using an etch such as NH₄OH+H₂O₂. These successive etches form isolation grooves through the stack 402, which can partially or fully run the vertical length of the module (e.g. 1 m), corresponding to lines 420 of mask 412. These etches also form isolation grooves through stack 402 corresponding to horizontal lines 422 and wide vertical lines 424 which divide the module into sub-modules.

Techniques such as those described in co-pending application Ser. No. 11/394,723 can be further used to form interconnects between cells in each sub-module, thereby forming the series connections described in connection with FIG. 3B.

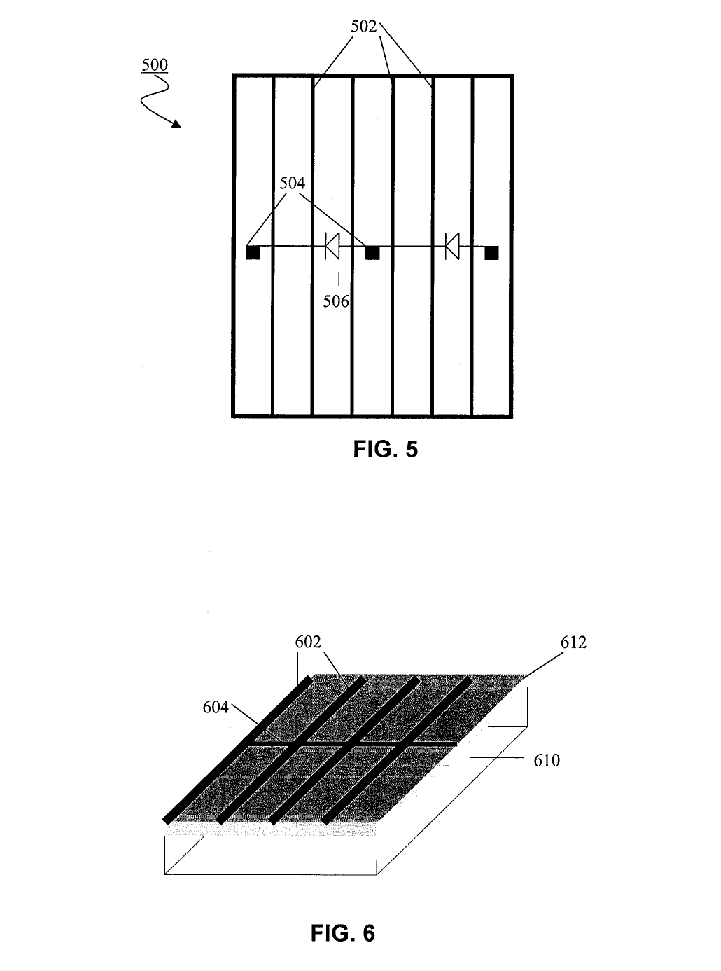

There are many advantages of using the photolithographic techniques described in the co-pending applications, as described above, in addition to being able to define much smaller interconnect regions (and thus much narrower cells) than is possible with other techniques such as laser scribing. For example, in some embodiments, during etching to form isolation grooves corresponding to lines 420, 422 and 424, aligned pad regions (e.g. having area of about 0.1 to 1 cm²) are also defined. These pad regions can be used for many useful purposes, such as to bond connections between cells or test points for module monitoring, as well as for bonding components to or between cells. For example, as further shown in FIG. 5, during etching to form isolation grooves 502 between cells in sub-module 500, pad regions 504 are also formed by etching a small area down to the metal layer in corresponding cells.

According to another aspect of the invention, it is preferred to connect external protect diodes for individual strings, so that power losses due to effects such as shading are minimized. This has been done in silicon modules in which numerous silicon solar cells are mounted on a backplane and wired together, but has not yet been possible with thin film modules. Accordingly, as further shown in FIG. 5, exposed pad regions 504 make it possible for protect diodes 506 to be connected between pad regions and wired in polarity so that they turn on if the region between the pads is reverse-biased. If a region corresponding to cell(s) between one of diodes 506 is shaded, for example, the cell(s) go into reverse bias and the protect diode turns on to shunt current that might otherwise flow through and damage the photovoltaic cells. Although FIG. 5 shows protect diode 506 connected between several cells, this is not necessary. One or any number of adjacent cells can be configured with protect diodes. Moreover, it is not necessary for every sub-module or cell to include protect diodes, much less that the same number of adjacent cells are so configured.

The invention contemplates many methods for wiring the protect diodes into the module. In the example embodiment shown above in FIG. 5, they can be placed as discrete components, much as is done with surface mount printed circuit boards.

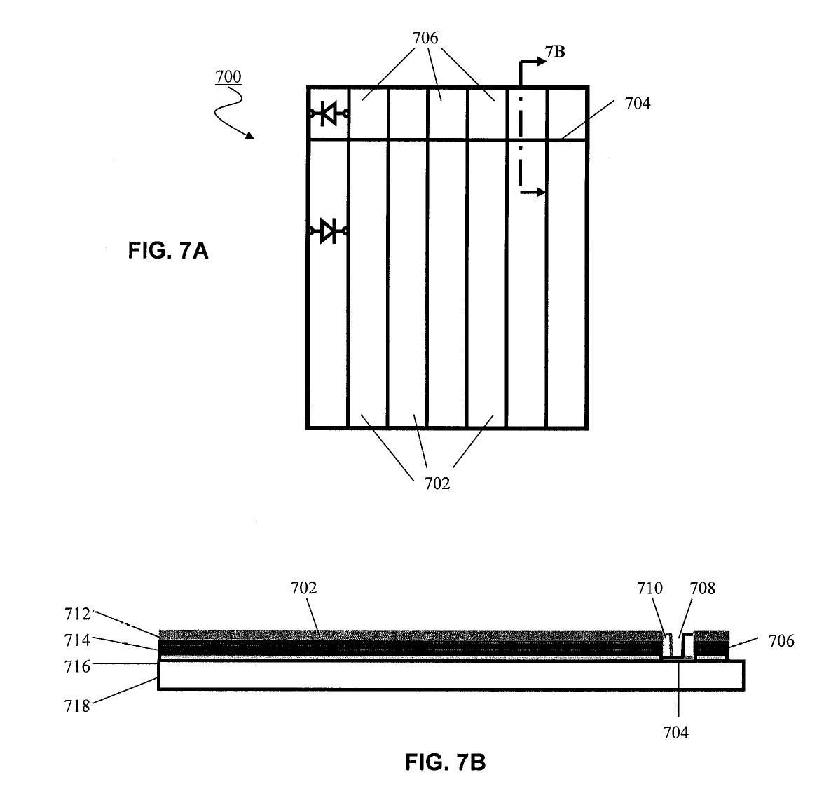

In certain other embodiments of the invention, the protect diodes can be fabricated as part of the lithographic process used to form the connections between adjacent cells. For example, as shown in FIG. 7A, during an etch step used to isolate adjacent cells in sub-module 700, a cut 704 can also be made to isolate regions adjacent to the cells 702 for forming protect diodes 706. In subsequent steps, contact ledges are formed for the protect diode at the same time and similar manner as the contact ledges are formed for the isolated cells as taught in co-pending application No. 11/394,721. When conductors are formed to wire adjacent cells together, the protect diodes are also wired to adjacent cells. In this manner, the protect diodes are formed as integrated elements without extra process steps, thereby forming a reliable connection at negligible additional cost.

FIG. 7B is a side cutaway view taken along the line 7B in FIG. 7A to illustrate how wiring can be performed to accomplish the reverse polarity of the diodes 706 versus the cells 702. The bottom layer 716 adjacent to substrate 718 is metal—typically molybdenum for cells 702 in which the semiconducting layer 714 is CIGS. The top layer 712 is a transparent conductor. Through the use of contact ledges (not shown) between the cells 702 and protect diodes 706 in the isolation cut 704, the top layer 712 of a protect diode 702 is wired via interconnect 708 to bottom layer 716 of cell 702, and the bottom layer 716 of diode 702 is wired via interconnect 710 to top layer 712 of cell 702. In this way, the protect diodes 706 can be wired in reverse polarity without use of extra process steps.

It should be noted that protect diodes 706 are not necessarily series-connected together like cells 702. It should be further noted that although FIG. 7A shows the one protect diode 706 per cell 702, this arrangement is not necessary and various configurations are possible.

Subsequent to, or in conjunction with forming interconnects within each sub-module, processing can be performed to create the parallel connections between sub-modules 302. For example, in some embodiments, busses run vertically with respect to the orientation in FIG. 3A to provide the parallel connection between sub-modules 302 in a given set 306.

More particularly, as shown in FIG. 6, in one embodiment the busses 602 are fabricated on the front of the module, on the same side of the substrate 610 as the active cells 612, and in areas corresponding to lines 424 in FIG. 4 that vertically divide the sub-modules into sets. In one example, busses 602 are comprised of plated nickel—in order to provide a thick conductor with minimum resistance—and are connected to cells by being deposited and patterned so that they terminate at the proper location, which may be a contact pad. Further, a bus 604 is also fabricated on the front of the module, and can be connected to busses 602, thereby providing a common output bus such as bus 320 shown in FIG. 3A. Bus 604 can be formed in areas corresponding to one of horizontal lines 422 in FIG. 4. Techniques such as those described more fully in co-pending application Ser. No. ______ (AMAT-10921) can be used to implement alternative embodiments of forming busses and interconnecting cells and/or areas.

Although not shown in FIG. 4, it will be appreciated that the sub-modules can be further wired to ground independently, or can share a common ground.

It should be noted that the sub-module connections need not reside within the module itself. Whereas a prior-art module has a single output, it is possible to make modules with multiple outputs, for example, having two separate terminals from each sub-module accessible to external circuitry. This provides a number of benefits. For example, there is greater flexibility in how an array is wired. In one example, three outputs are provided: a common output, one positive with respect to common, and one negative with respect to common. This enables use of a simpler DC to AC converter, since switching is done over only half of the AC cycle. Regions with more likelihood of shading may be electrically separated from regions with less likelihood, such as the bottom versus the top of the array. Also, arrays may be made much larger, thereby saving packaging costs at the module level; for example, instead of cutting a Gen 8 substrate into 5 modules, each 1 m² in area, the single substrate could be packaged as a module with five outputs, each representing a sub-module area of 1 m².

In other embodiments, a switching system is built into or externally from the module that controls switches that selectively connect sub-modules together, rather than having fixed connections. This system can dynamically measure part or all of the current-voltage characteristic of each sub-module and use electronic switches to dynamically re-wire the sub-modules together to optimize output. In this manner, degradation due to defects, shading, or other non-uniform effects is dynamically minimized.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A thin-film photovoltaic module comprising:
a substrate;
a first region on the substrate including two or more first photovoltaic cells series-connected between first and second nodes; and
a second region on the substrate including two or more second photovoltaic cells series-connected between third and fourth nodes different from the first and second nodes.

2. A module according to claim 1 further comprising a connection between the first and second regions.

3. A module according to claim 2 wherein the connection connects the first node to the third node and the second node to the fourth node.

4. A module according to claim 1 wherein the first region has a first area different from a second area of the second region.

5. A module according to claim 4, wherein the first and second areas are different so as to compensate for non-uniformity from a manufacturing process.

6. A module according to claim 1, wherein the first and second regions comprise a slack of photovoltaic material, and wherein the stack includes at least one metal conductor layer, the module further comprising a contact pad exposing a portion of the metal conductor layer in one of the first and second regions.

7. A module according to claim 1 further comprising at least one additional region with photovoltaic cells series-connected between separate respective nodes.

8. A module according to claim 1 further comprising at least eight additional regions with photovoltaic cells series-connected between separate respective nodes.

9. A module according to claim 2 wherein the connection and the regions are fabricated over the same surface of the substrate.

10. A module according to claim 1, wherein the first and second nodes are connected to first output terminals and the third and fourth nodes are connected to separate second output terminals.

11. A module according to claim 1, wherein the first region has a non-rectangular shape.

12. A method of configuring a thin-film photovoltaic module comprising:
forming a first region on the substrate including two or more first photovoltaic cells series-connected between first and second nodes; and
forming a second region on the substrate including two or more second photovoltaic cells series-connected between third and fourth nodes different from the first and second nodes.

13. A method according to claim 12 further comprising forming a connection between the first and second regions within the module.

14. A method according to claim 13 wherein the connection connects the first mode to the third node and the second node to the fourth node.

15. A method according to claim 12 wherein the first region has a first area different from a second area of the second region.

16. A method according to claim 15, further comprising adjusting the first and second areas so as to compensate for non-uniformity from a manufacturing process.

17. A method according to claim 12, wherein the first and second regions comprise a stack of photovoltaic material, and wherein the stack includes at least one metal conductor layer, the method further comprising forming a contact pad by exposing a portion of the metal conductor layer in one of the first and second regions.

18. A method according to claim 13 wherein the step of forming the connection includes fabricating the connection over a surface of the substrate opposite from a surface on which the regions are formed.

19. A method according to claim 12 wherein the forming steps include lithographic processes.

20. A method according to claim 12 wherein the forming steps include laser scribing steps.

21. A method according to claim 12 further comprising:
sensing outputs of the first and second regions; and
dynamically adjusting connections between the regions to reduce losses due to non-uniformity.

22. A thin film photovoltaic module comprising:
a first photovoltaic cell having a first area; and
a second photovoltaic cell having a second area different from the first area.

23. A module according to claim 22, wherein the first and second areas are adjusted to compensate for first and second different short-circuit currents in the first and second cells, respectively.

24. A module according to claim 22, wherein the first and second areas are adjusted to compensate for process variations in the first and second cells, respectively.

25. A thin-film photovoltaic module comprising:
a substrate;
a region on the substrate including a plurality of photovoltaic cells series-connected together between first and second ones of the cells, the first and second cells being further connected to first and second nodes, and
wherein the cells are formed from a stack of photovoltaic material on the substrate, and wherein the stack includes at least one metal conductor layer, the module further comprising a contact pad exposing a portion of the metal conductor layer in a third one of the cells different from the first and second cells.

26. A module according to claim 25, further comprising:
a second contact pad exposing a portion of the metal conductor layer in a fourth one of the cells different from the first and second cells; and
an electrical component connected between the contact pad and second contact pad.

27. A module according to claim 26, wherein the component comprises a protect diode.

28. A thin-film photovoltaic module comprising:
a substrate;
a first region on the substrate including a plurality of photovoltaic cells series-connected together, wherein the cells are formed from a first stack of photovoltaic material on the substrate; and
a second region on the substrate including at least one protect diode connected to certain of the photovoltaic cells, wherein the protect diode is formed from a second stack of the photovoltaic material on the substrate.

29. A thin-film photovoltaic module comprising:
a substrate;
a first region on the substrate including a plurality of photovoltaic cells series-connected together, wherein the first region has a non-rectangular shape.
